(19) United States
(12) Patent Application Publication
(10) Pub. No.: US 2023/0001614 A1
(43) Pub. Date: Jan. 5, 2023

(54) LOCKING UNIT FOR ONE SHAPING MACHINE

(71) Applicant: ENGEL AUSTRIA GmbH, Schwertberg (AT)

(72) Inventors: Stephan EPPICH, Arbing (AT); David SULZBACHNER, Ried in der Riedmark (AT)

(21) Appl. No.: 17/855,986

(22) Filed: Jul. 1, 2022

(30) Foreign Application Priority Data
Jul. 2, 2021 (AT) A 50555/2021

(51) Int. Cl. B29C 45/67

(52) U.S. Cl. CPC B29C 45/6707; B29C 2045/6757

(57) ABSTRACT

Clamping unit for a molding machine, in particular for an injection-molding machine, with a machine frame, an end plate arranged on the machine frame, a platen movably mounted on the machine frame, a stationary platen arranged on the machine frame, at least two, in particular four, tie bars, via which a clamping force can be transmitted, and a mold height adjustment apparatus for adjusting the mold height for a molding tool which can be or is fitted on the platen, wherein the mold height adjustment apparatus has

i. a rotatable adjustment element gripping on at least one tie bar,
ii. a drive device for rotating the rotatable adjustment element and
iii. a locking device for securing the rotatable adjustment element against a rotational movement relative to the at least one tie bar.

The present invention, according to a first aspect, relates to a clamping unit for a molding machine, in particular for an injection-molding machine, with a machine frame, an end plate arranged on the machine frame, a platen movably mounted on the machine frame, a stationary platen arranged on the machine frame, at least two, in particular four, tie bars, via which a clamping force can be transmitted, and a mold height adjustment apparatus for adjusting the mold height for a molding tool which can be or is fitted on the platens. In addition, the invention relates to a molding machine with such a clamping unit.

In generic clamping units with a toggle lever, mold height adjustment apparatuses are used after a tool change to a molding tool with a different mold height has been effected. In such clamping units with a toggle lever and with tie bars, such a mold height adjustment is usually carried out by rotation of an adjustment nut (adjustment element) via the adjustment thread formed on the tie bar.

Examples of such or similar mold height adjustment apparatuses are found in DE 10 2016 119 840 A1, WO 2015/024657 A1 and DE 10 2015 011 425 A1.

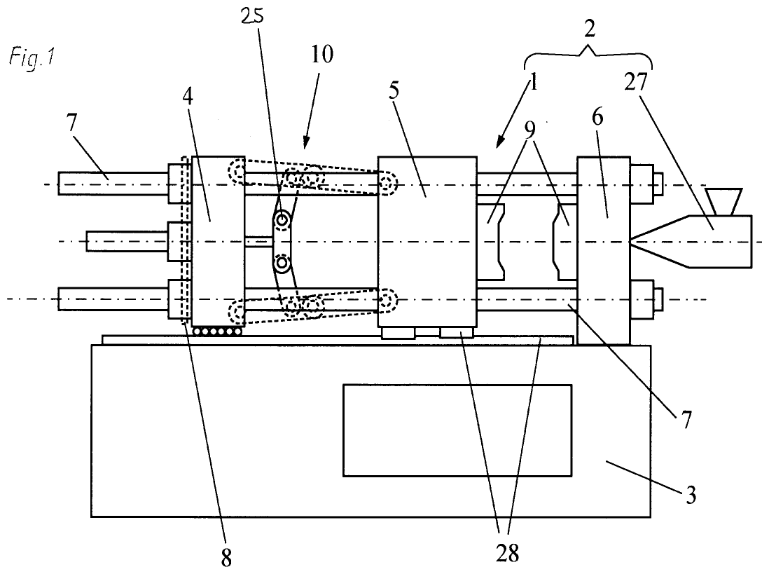

DE 26 23 392 A1 relates to a mold clamping unit. The adjustment carrier plate is adjustable relative to the tie bars, which are in threaded engagement with the tie bar ends, by means of rotatable adjustment threaded sleeves. The adjustment threaded sleeves provided with external teeth can be driven synchronously with a single, manually actuatable driving element. Locking threaded sleeves, which are likewise in threaded engagement with the tie bar ends, are coupled to the adjustment threaded sleeves. The coupling is such that a synchronous rotation is compelled without preventing an axial relative movement of the parts rotationally coupled to one another. The locking threaded sleeves are axially loadable with the aid of loading plates. As a result of the loading, in the case of a slight axial shift, the internal threads of the locking threaded sleeves are wedged with the external threads of the associated tie bars and a rotation is thereby blocked. In the embodiment example of FIGS. 1 to 4, the locking threaded sleeves can be axially braced with the aid of screw bolts with adjustment threaded sleeves and can thus additionally be blocked by threaded wedging, i.e. even without loading plates.

Finally, EP 1 321 272 B1, which is non-generic and shows a two-plate machine, describes a method and a device for adjusting the installation height of a tool in order to eliminate, as far as possible, the relative movement between the movable platen and the tie bars. For this, an adjustment element, which is adjustable axially relative to the tie bar via a central drive, is connected in a positive-locking manner to each tie bar, wherein at least one of the adjustment elements can be locked against an axial movement and against twisting by means of a locking mechanism, wherein the locking mechanism is a displaceable piston.

A disadvantage in the generic clamping units with mold height adjustment apparatus is, among other things, that the guides of these apparatuses are usually not play-free. Thus, in the case of a pull-push loading, which occurs for example when the mold is opened and closed, this play must be passed through. This can cause noise. In addition, it can be the case that the adjustment nut additionally rotates in the tooth clearance of the transmission element of the drive device.

The object of the first aspect of the present invention is therefore to create an alternative or improved clamping unit. In particular, the disadvantages known in the generic state of the art are to be avoided.

This is achieved by a clamping unit with the features of claim 1. According to this, it is provided according to the invention, among other things, that the mold height adjustment apparatus has a rotatable adjustment element gripping on at least one tie bar, a drive device for rotating the rotatable adjustment element and a locking device for securing the rotatable adjustment element against a rotational movement relative to the at least one tie bar.

Preferred embodiment examples of the present invention are given in the dependent claims and in the description.

In order to carry out the opening and closing of the molding tool, it is preferably provided that a platen drive mechanism, preferably a toggle lever mechanism—separate from the drive device—for moving the movable platen between an open position of the molding tool and a closed position of the molding tool is arranged between the end plate and the movable platen. This drive mechanism can for example be driven hydraulically or electrically.

The precise mechanical formation of the adjustment element is as desired per se, as long as a relative movement between end plate and tie bars is made possible. It is preferably provided that the rotatable adjustment element is formed as an adjustment nut with an internal thread, wherein this internal thread correspondingly grips on an external thread formed on at least one tie bar.

The transmission of the movement of the drive device to the adjustment element can be effected for example via a belt or a chain. However, it is preferably provided that the rotatable adjustment element has a gearwheel-shaped outer surface, wherein this gearwheel-shaped outer surface meshes with a gear rim of the drive device.

It is preferably provided that the drive device has a drive motor, a gearwheel rotatably driven by the drive motor and the gear rim meshing with the gearwheel.

It can be provided that an adjustment element of a mold height adjustment apparatus is provided only on one or two (diagonally opposite) tie bars. It is preferably provided that the mold height adjustment apparatus has an adjustment element on four tie bars in each case.

Specifically, it is provided that the rotating gear rim meshes with all four adjustment elements at the same time, with the result that a secure and uniform mold height adjustment along the tie bars is made possible.

It can be provided that a locking device for securing one of the adjustment elements is provided only on one or two (diagonally opposite) tie bars. It is preferably provided that one locking device is assigned to each adjustment element.

Specifically, it is provided that the mold height adjustment apparatus has four rotatable adjustment elements, each gripping on a tie bar, a drive device for rotating the four rotatable adjustment elements and four locking devices for securing the respective rotatable adjustment element against a rotational movement relative to the respective tie bar.

Two preferred embodiment variants are provided for the formation of the at least one locking device. Thus, the locking device can be formed as an electrically actuatable braking device or as a hydraulically actuatable braking device. It is also possible to provide a combination of both variants in one clamping unit.

In the first variant, it is particularly preferably provided that this electrically actuatable braking device has a brake disk secured on the rotatable adjustment element and brake shoes, and in a braking position the brake shoes secure the brake disk between the brake shoes against a rotational movement.

Furthermore, it is preferably provided that the brake shoes are fitted on the end plate via a support, wherein the brake shoes are mounted movable via an electrical drive unit (along the machine's longitudinal axis) relative to the support.

Specifically, the braking system known under the trade name ROBA® Diskstop® for brake disks can be used as locking device.

A performance-optimized braking power of over 3,000 N (specifically 3,232 N) with a maximum braking torque per tie bar of approximately 640 Nm can be provided.

However, a braking power “without overexcitation” of below 2,000 N (specifically 1,939 N) with a maximum braking torque per tie bar of approximately 387 Nm can also be provided.

In the second variant, it is particularly preferably provided that this hydraulically actuatable braking device has a flange element which is fitted on the end plate and which surrounds the rotatable adjustment element at least in areas, an annular pressure chamber which is formed between an outer surface of the adjustment element and an inner surface of the flange element and is delimited by two seals, a feed channel, formed in the flange element, for feeding a hydraulic pressure medium into the annular pressure chamber, and a braking surface, via which the adjustment element contacts the end plate.

With respect to the mode of operation, it is provided that pressure, preferably between 20 and 80 bar, can be applied to the adjustment element by the hydraulically actuatable braking device via the hydraulic pressure medium in the pressure chamber, with the result that the braking surface of the adjustment element is pressed against the end plate and the adjustment element is secured against a rotational movement by the friction between adjustment element and end plate.

In order to prevent wear that is too great and rapid, it is preferably provided that the adjustment element has a wear ring, wherein the braking surface is formed on this wear ring.

In order to make it possible for the pressure to be able to be applied as uniformly as possible to the adjustment element around the entire adjustment element, it is preferably provided that an annular groove is formed on the inner surface of the adjustment element delimiting the pressure chamber.

The contact pressure of the individual adjustment element is approximately 50 bar, which corresponds to approximately 40 kN.

According to a second aspect, the present invention relates to a clamping unit for a molding machine, in particular for an injection-molding machine, with a machine frame, optionally an end plate, a platen movably mounted on the machine frame, a stationary platen fitted on the machine frame, a hydraulic mold height adjustment apparatus for adjusting the mold height for a molding tool which can be or is fitted on the platen, a platen drive mechanism for moving the movable platen relative to the stationary platen and a lubricant system for supplying lubricating points of the platen drive mechanism.

Mold height adjustment apparatuses have to be used relatively infrequently during operation of a molding machine, which is why that is a good starting point for cost savings during production.

The object of this second aspect of the invention is therefore to create a clamping unit that is an alternative to or more cost-favorable than the state of the art. In particular, synergies are intended to result from the components of the clamping unit that are already present.

This is achieved by a clamping unit with the features of claim 12. According to this, it is provided according to the invention that the lubricant system and the hydraulic mold height adjustment apparatus have a common pump for feeding pressurized lubricant to the lubricant system and/or to the mold height adjustment apparatus.

The pump and the lubricant thus have a dual function: they serve to supply and lubricate the platen drive mechanism and additionally to drive or pressurize the brake for the mold height adjustment apparatus. It is thereby possible for example for the (lubricating) pump to be used, in the case of otherwise fully electrical machines, to apply the oil pressure for the mold height adjustment.

DE 102 46 731 A1, which relates to the energy supply of the hydraulic drive being effected by the lubricant pump in the case of an injection-molding apparatus, is known from the state of the art. This hydraulic drive is used for the infrequently performed clamping of the molding tool against the platen. A mold height adjustment is not involved.

According to a preferred embodiment example, it is provided that the hydraulic mold height adjustment apparatus is or can be fluidically connected to the lubricant system and pressurized lubricant of the lubricant system can be fed to the hydraulic mold height adjustment apparatus by the lubricant pump.

Furthermore, it is preferably provided that a locking device for securing a rotatable adjustment element of the mold height adjustment apparatus against a rotational movement is fluidically connected to the lubricant system.

There is thus no need to use a separate hydraulic circuit for the mold height adjustment (and the associated braking movement). Rather, the lubricant pump which is present and used without other lubricating points (e.g. in the toggle lever system) can also supply the mold height adjustment hydraulics.

It is preferably provided that an axial play of the rotatable adjustment element of the mold height adjustment apparatus in the flange element can be eliminated by a pressing of the rotatable adjustment element of the mold height adjustment apparatus against the end plate.

Protection is also sought for a molding machine with an injection unit and a clamping unit according to the invention (according to the first and/or the second aspect).

A common control or regulating unit for controlling or regulating the mold height adjustment apparatus and the platen drive mechanism is particularly preferably provided.

Specifically, the drive device of the mold height adjustment apparatus, the brake shoes of the locking device, the lubricant pump and/or the platen drive mechanism can be centrally controlled and regulated with this control or regulating unit.

In general, it may be mentioned that all embodiment examples and preferred features apply to both aspects of the invention, as long as this makes technical sense in each case.

Further details and advantages of the present invention are explained in more detail below with the aid of the description of the figures with reference to the embodiment examples represented in the drawings. There are shown in:

FIG. 1, schematically, a molding machine in an open position in the case of a small mold height,

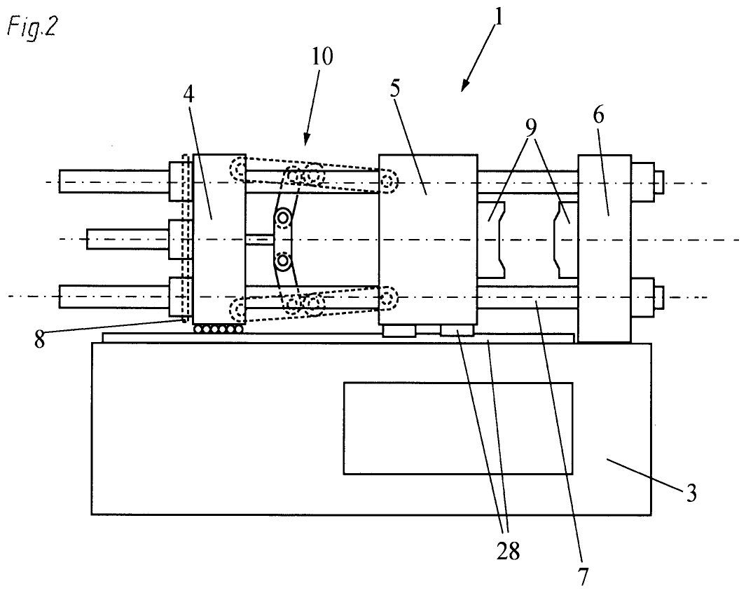

FIG. 2, schematically, a molding machine in an open position in the case of a larger mold height of the molding tool,

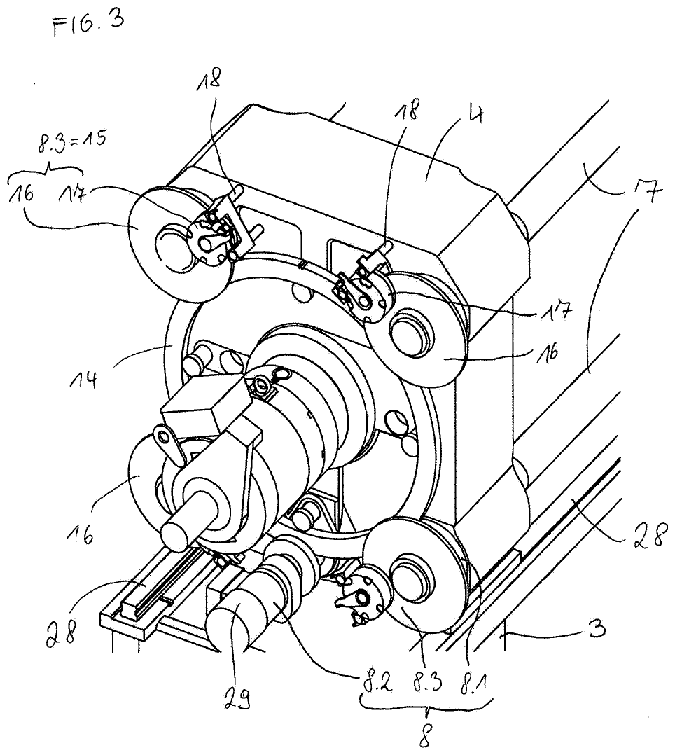

FIGS. 3 to 6 various views of a mold height adjustment apparatus with an electrically actuatable braking device,

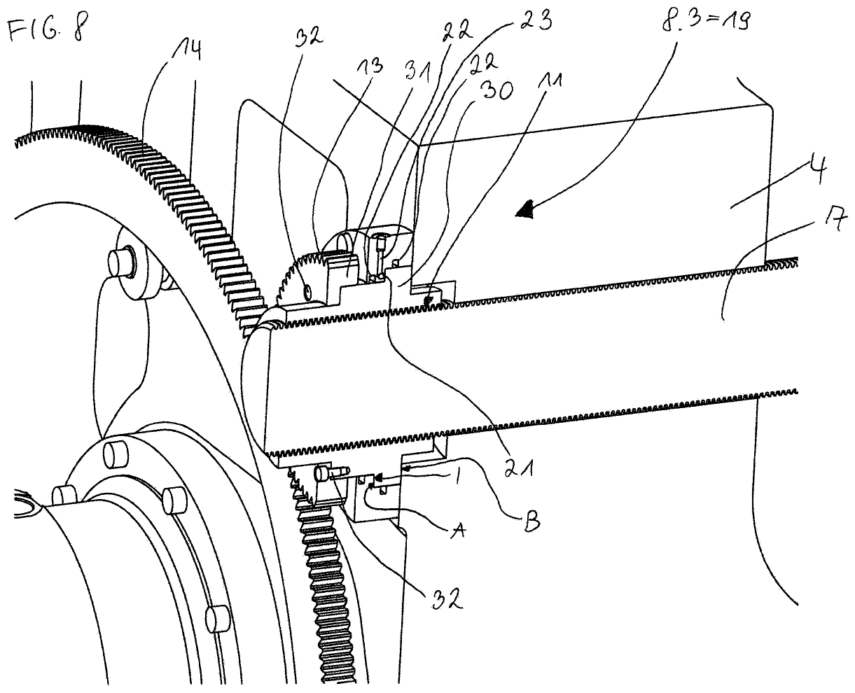

FIGS. 7 to 10 various views of a mold height adjustment apparatus with a hydraulically actuatable braking device and

FIG. 11, schematically, a lubricant system with lubricating points and a mold height adjustment apparatus.

FIG. 1 schematically shows a molding machine 2 in the form of a 3-plate injection-molding machine. However, the molding machine 2 can also be a molding press or transfer-molding press.

Specifically, the molding machine 2 has an injection unit 27, only indicated schematically, and a clamping unit 1, represented in more detail. The stationary platen 6 is fastened to a machine frame 3 of this clamping unit 1. The movable platen 5 and the end plate 4 are movably mounted on the frame 3 via the guide 28.

By way of example, a lubricating point 25 in the form of a toggle lever bolt is marked.

In addition, tie bars 7 are provided, along which the relative movements of the movable platen 5 and the end plate 4 are effected. A relative movement between the end plate 4 and the movable platen 5 is effected via a suitable platen drive mechanism 10. In this case, this is formed as a toggle lever mechanism.

If other mold halves of a molding tool 9 are now clamped against the platens 5 and 6, it is usually necessary also to carry out an adaptation to the different mold height that usually exists then. In other words, in an open position of the molding tool, as shown in FIGS. 1 and 2, the distance between the movable platen 5 and the stationary platen 6 is altered correspondingly.

This alteration or adaptation is effected via the mold height adjustment apparatuses 8, only indicated schematically in FIGS. 1 and 2. In principle, only one such mold height adjustment apparatus 8 has to be provided. In the case of a 3-plate machine, as represented in FIGS. 1 and 2, this mold height adjustment apparatus 8 can be arranged or formed in or on the end plate 4.

A movement of the end plate 4, lever and the movable platen 5 relative to the machine frame 3 is triggered via this mold height adjustment apparatus 8. The stationary platen 6 is firmly connected to the machine frame 3, thus a relative adjustment between the two platens 5 and 6 is also always effected.

An end plate 4 with a mold height adjustment apparatus 8 is represented in perspective in FIG. 3, wherein this mold height adjustment apparatus 8 is formed as an electrically actuatable braking device 15.

The mold height adjustment apparatus 8 has four rotatable adjustment elements 8.1, each gripping on a tie bar 7, a drive device 8.2 for rotating the rotatable adjustment elements 8.1 and four locking devices 8.3 for securing the rotatable adjustment elements 8.1 against a rotational movement relative to the respective tie bar 7.

The drive device 8.2 has an electric motor 29, which rotatably drives the gear rim 14 via a rotatable pinion. This gear rim 14 meshes, with its teeth formed on the outer surface, on the gearwheel-shaped outer surfaces 13 of the adjustment elements 8.1 (these are concealed by the brake disks 16 in the representation according to FIG. 3).

The locking devices 8.3 represented in FIG. 3 in the form of electrically actuatable braking devices 15 in each case have a brake disk 16 secured on the rotatable adjustment element 8.1 and brake shoes 17. In a braking position, the brake disks 16 are secured between the brake shoes 17 against a rotational movement.

The brake shoes 17 are fitted on the end plate 4 via a support 18, wherein the brake shoes 17 are mounted movable via an electrical drive unit relative to the support 18.

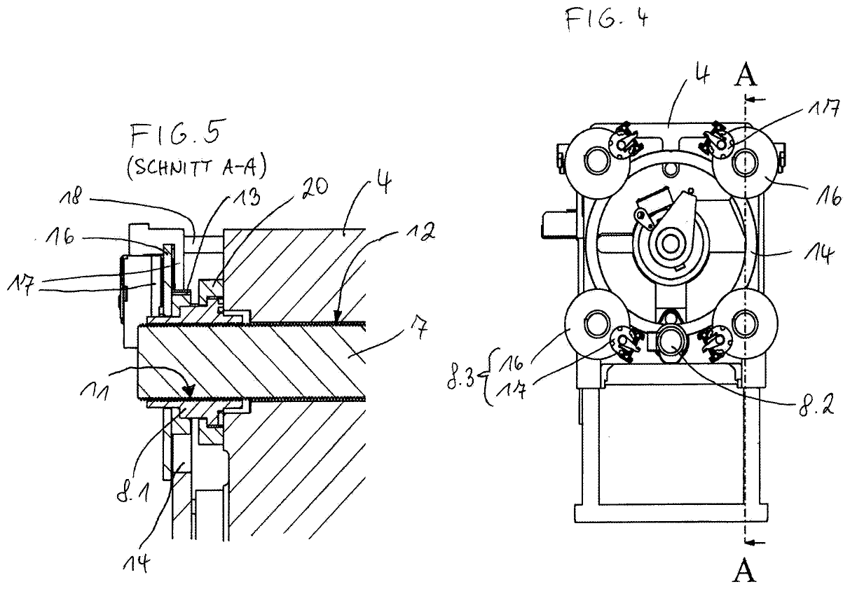

A front view of the end plate 4 together with mold height adjustment apparatus 8 according to FIG. 3 is represented in FIG. 4. The section line A-A is marked in this FIG. 4.

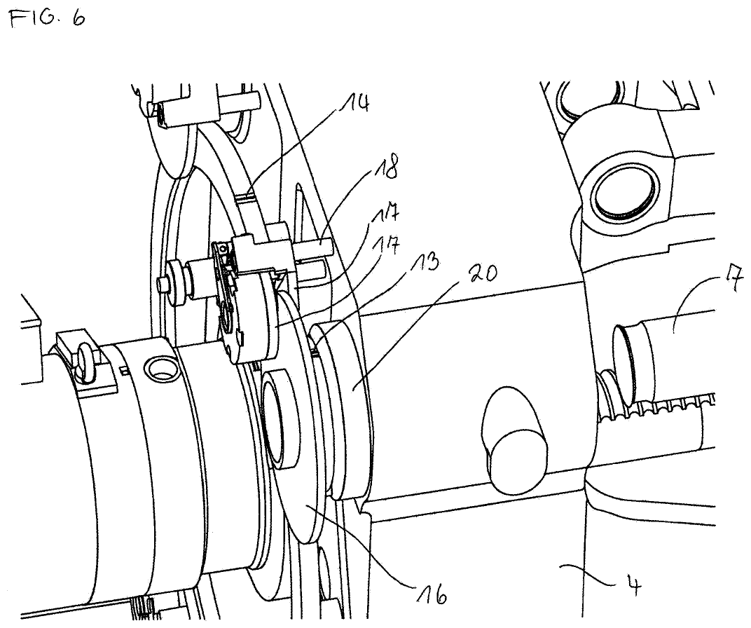

FIG. 5 shows the upper area of the cross section according to the section line A-A. It can easily be seen that the rotatable adjustment element 8.1 is formed as an adjustment nut 30 with an internal thread 11, wherein this internal thread 11 correspondingly grips on an external thread 12 formed on at least one tie bar 7.

The adjustment element 8.1 is rotatably mounted between the flange element 20 secured on the end plate 4 and the end plate 4. The gearwheel-shaped outer surface 13 which is formed on the adjustment element 8.1 and which is connected to the gear rim 14 in a movement-transmitting manner can be seen in this FIG. 5.

The two brake shoes 17 movable relative to each other and the brake disk 16 which can be wedged between these brake shoes 17 can also be easily seen in the cross section according to FIG. 5.

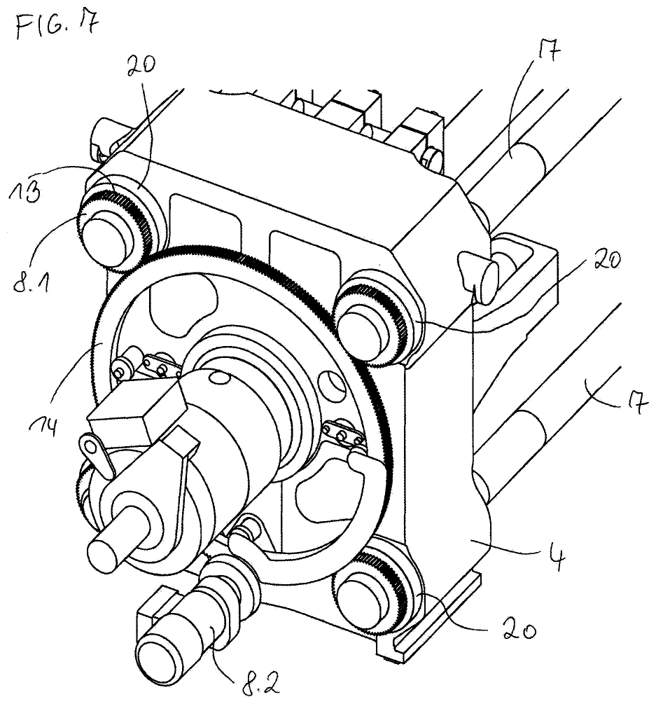

FIG. 6 shows a further perspective of the mold height adjustment apparatus 8 with an electrically actuatable braking device 15, wherein the tie bars 7 are not visible. The teeth, only indicated schematically, of the gear rim 14 and of the gearwheel-shaped outer surface 13 of the rotatable adjustment element 8.1 can be seen.

In FIGS. 7 to 10, the locking device 8.3 is formed as a hydraulically actuatable braking device 19.

FIG. 7 shows the end plate 4 with tie bars 7 and the mold height adjustment apparatus 8 attached on the end side in perspective. The drive device 8.1, the gear rim 14 and the adjustment element 8.1 are formed the same as in the first embodiment variant according to FIGS. 3 to 6.

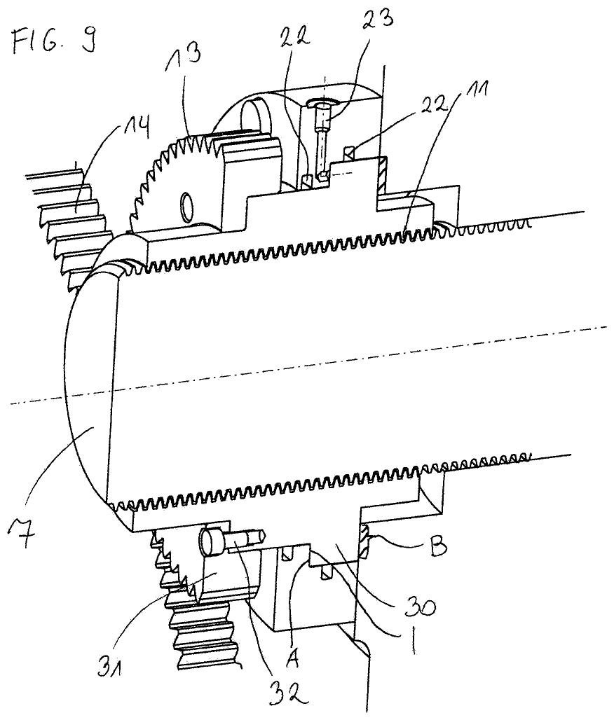

The essential components of the hydraulically actuatable braking device 19 are formed in the flange elements 20, wherein details can be easily seen in FIGS. 8 to 10.

The adjustment element 8.1 is formed multi-part in the perspective cross section according to FIG. 8. This adjustment element 8.1 has the adjustment nut 30 with the internal thread 11, the gearwheel 31 with the gearwheel-shaped outer surface 13 and several fastening means 32 for connecting the adjustment nuts 30 to the gearwheel 31.

The hydraulically actuatable braking device 19 has several components:

One component is a flange element 20 which is fitted on the end plate 4 and which surrounds the rotatable adjustment element 8.1 at least in areas.

A further component is an annular pressure chamber 21, which is formed between an outer surface A of the adjustment element 8.1 and an inner surface I of the flange element 20 and is delimited by two seals 22.

In addition, the braking device 19 has a feed channel 23, formed in the flange element 20, for feeding a hydraulic pressure medium into the annular pressure chamber 21 and a braking surface B, via which the adjustment element 8.1 contacts the end plate 4.

Pressure can be applied to the adjustment element 8.1 by the hydraulically actuatable braking device 19 via the hydraulic pressure medium in the pressure chamber 21. The braking surface B of the adjustment element 8.1 is thereby pressed against the end plate 4. The adjustment element 8.1 is secured against a rotational movement by the friction between adjustment element 8.1 and end plate 4.

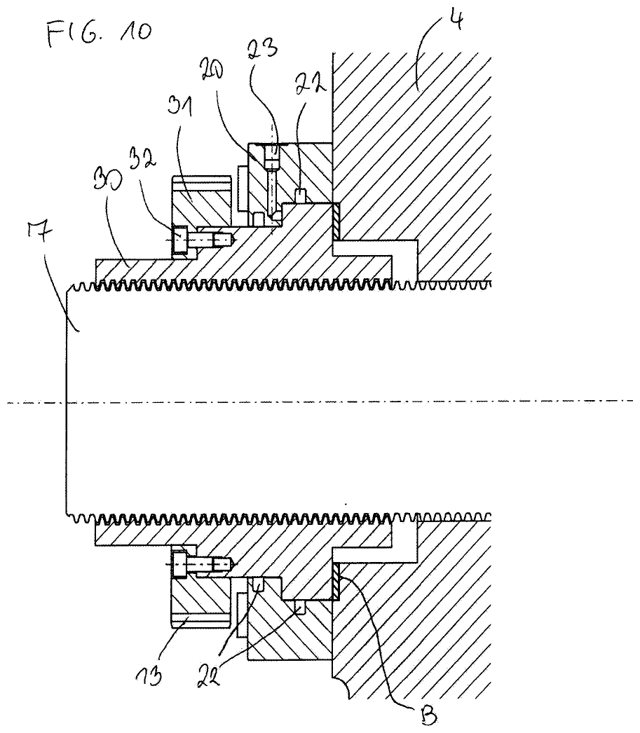

The components of the braking device 19 are represented even larger in FIG. 9. The grooves—in this case represented empty—in which the annular seals 22 for delimiting the pressure chamber 21 are arranged can be seen.

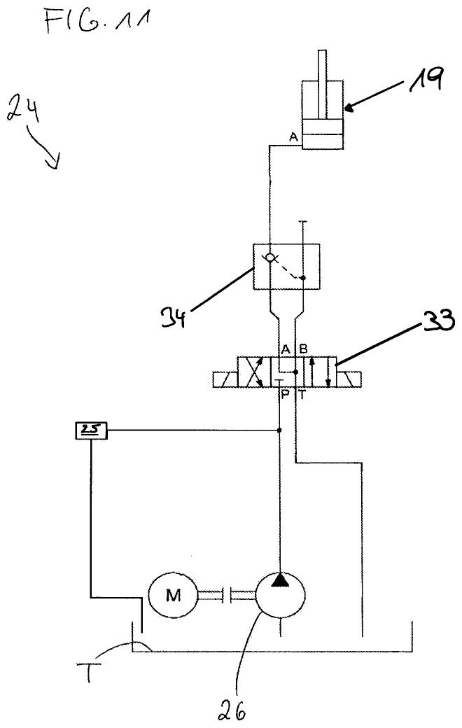

A cross section matching the previous figures is represented in FIG. 10. The adjustment element 8.1 can have a wear ring B, wherein the braking surface B is formed on this wear ring.

In order to make a uniform pressure application possible, an annular groove (not represented) can be formed on the inner surface I of the flange element 20 delimiting the pressure chamber 21. Alternatively or additionally, an annular groove (not represented) can also be formed on the outer surface A of the adjustment element 8.1.

A lubricant system 24 is represented schematically in FIG. 11. This lubricant system 24 has a motor M and a pump 26 driven by this motor M, wherein lubricant can be drawn out of the tank T via the pump 26.

The lubricating points 25 are arranged between the switch element 33 (e.g. in the form of a manifold valve) and the pump 26. Via a switchable check valve 34, an unloading of the hydraulically actuatable braking device 19 can be effected in a further switch position of the switch element 33 (a position moved towards the right).

### LIST OF REFERENCE NUMBERS

1 clamping unit
2 molding machine
3 machine frame
4 end plate
5 movable platen
6 stationary platen
7 tie bars
8 mold height adjustment apparatus
8.1 rotatable adjustment element
8.2 drive device
8.3 locking device
9 molding tool
10 platen drive mechanism
11 internal thread
12 external thread
13 gearwheel-shaped outer surface
14 gear rim
15 electrically actuatable braking device
16 brake disk
17 brake shoes
18 support
19 hydraulically actuatable braking device
20 flange element
21 pressure chamber
22 seals
23 feed channel
24 lubricant system
25 lubricating points
26 pump
27 injection unit
28 guide
29 electric motor
30 adjustment nut
31 gearwheel
32 fastening means
33 switch element
34 switchable check valve
A outer surface of the adjustment element
B wear ring
I inner surface of the flange element
B braking surface
M motor
T tank

1. A clamping unit for a molding machine, in particular for an injection-molding machine, comprising:
a machine frame,
an end plate arranged on the machine frame,
a platen movably mounted on the machine frame,
a stationary platen arranged on the machine frame,
at least two, in particular four, tie bars, via which a clamping force can be transmitted, and
a mold height adjustment apparatus for adjusting the mold height for a molding tool which can be or is fitted on the platen, wherein the mold height adjustment apparatus includes:
i. a rotatable adjustment element gripping on at least one tie bar,
ii. a drive device for rotating the rotatable adjustment element and
iii. a locking device for securing the rotatable adjustment element against a rotational movement relative to the at least one tie bar.

2. The clamping unit according to claim 1, wherein a platen drive mechanism, preferably a toggle lever mechanism, for moving the movable platen between an open position of the molding tool and a closed position of the molding tool is arranged between the end plate and the movable platen.

3. The clamping unit according to claim 1, wherein the rotatable adjustment element is formed as an adjustment nut with an internal thread, wherein this internal thread correspondingly grips on an external thread formed on at least one tie bar.

4. The clamping unit according to claim 1, wherein the rotatable adjustment element has a gearwheel-shaped outer surface, wherein this gearwheel-shaped outer surface meshes with a gear rim of the drive device.

5. The clamping unit according to claim 1, wherein the locking device is formed as an electrically actuatable braking device.

6. The clamping unit according to claim 5, wherein this electrically actuatable braking device has a brake disk secured on the rotatable adjustment element and brake shoes, and in a braking position the brake shoes secure the brake disk between the brake shoes against a rotational movement.

7. The clamping unit according to claim 6, wherein the brake shoes are fitted on the end plate via a support, wherein the brake shoes are mounted movably via an electrical drive unit relative to the support.

8. The clamping unit according to claim 1, wherein the locking device is formed as a hydraulically actuatable braking device.

9. The clamping unit according to claim 8, wherein this hydraulically actuatable braking device has
a flange element which is fitted on the end plate and which surrounds the rotatable adjustment element at least in areas,
an annular pressure chamber, which is formed between an outer surface of the adjustment element and an inner surface of the flange element and is delimited by two seals,
a feed channel formed in the flange element for a hydraulic pressure medium into the annular pressure chamber and
a braking surface, via which the adjustment element contacts the end plate, wherein pressure, preferably between 20 and 80 bar, can be applied to the adjustment element by the hydraulically actuatable braking device via the hydraulic pressure medium in the pressure chamber, with the result that the braking surface of the adjustment element is pressed against the end plate and the adjustment element is secured against a rotational movement by the friction between adjustment element and end plate.

10. The clamping unit according to claim 9, wherein the adjustment element has a wear ring, wherein the braking surface is formed on this wear ring.

11. The clamping unit according to claim 9, wherein an annular groove is formed on the inner surface of the flange element which inner surface delimits the pressure chamber.

12. A clamping unit for a molding machine, in particular for an injection-molding machine, comprising:
a machine frame,
a platen movably mounted on the machine frame,
a stationary platen arranged on the machine frame,
a hydraulic mold height adjustment apparatus for adjusting the mold height for a molding tool which can be or is fitted on the platen,
a platen drive mechanism for moving the movable platen relative to the stationary platen and
a lubricant system for supplying lubricating points of the platen drive mechanism,
wherein the lubricant system and the hydraulic mold height adjustment apparatus have a common pump for feeding pressurized lubricant to the lubricant system and/or to the mold height adjustment apparatus.

13. The clamping unit according to claim 12, wherein the hydraulic mold height adjustment apparatus is or can be fluidically connected to the lubricant system and pressurized lubricant of the lubricant system can be fed to the hydraulic mold height adjustment apparatus by the pump.

14. The clamping unit according to claim 12, wherein a locking device for securing a rotatable adjustment element of the mold height adjustment apparatus against a rotational movement is fluidically connected to the lubricant system.

15. The clamping unit according to claim 12, wherein an axial play of the rotatable adjustment element of the mold height adjustment apparatus in the flange element can be eliminated by a pressing of the rotatable adjustment element of the mold height adjustment apparatus against the end plate.

16. A molding machine comprising an injection unit and the clamping unit according to claim 1.

17. The molding machine according to claim 16, wherein a common control or regulating unit for controlling or regulating the mold height adjustment apparatus and the platen drive mechanism, and optionally the pump, is provided.
